(19) United States
(12) Patent Application Publication
(10) Pub. No.: US 2026/0015984 A1
(43) Pub. Date: Jan. 15, 2026

(54) CONTROL DEVICE FOR INTERNAL COMBUSTION ENGINE

(71) Applicant: TOYOTA JIDOSHA KABUSHIKI KAISHA, Toyota-shi (JP)

(72) Inventor: Keiichiro AOKI, Shizuoka-ken (JP)

(73) Assignee: TOYOTA JIDOSHA KABUSHIKI KAISHA, Toyota-shi (JP)

(21) Appl. No.: 19/089,182

(22) Filed: Mar. 25, 2025

(30) Foreign Application Priority Data
Jul. 10, 2024 (JP) 2024-110816

(51) Int. Cl. F02D 41/14

(52) U.S. Cl. CPC F02D 41/1454; F02D 41/1441; F02D 41/1487

(57) ABSTRACT

The control device controls the air-fuel ratio of the air-fuel mixture based on the output value of the downstream-side air-fuel ratio sensor until a period from the engine startup start until the oxygen occlusion capability function is obtained in the catalyst elapses. The control device performs air-fuel ratio control of the air-fuel mixture on the basis of the output value of the upstream-side air-fuel ratio sensor after the elapse of the period from the engine startup start until the oxygen occlusion capability function is obtained in the catalyst.

### CROSS-REFERENCE TO RELATED APPLICATION

This application claims priority to Japanese Patent Application No. 2024-110816 filed on Jul. 10, 2024, incorporated herein by reference in its entirety.

### BACKGROUND

### 1. Technical Field

The present disclosure relates to a control device for an internal combustion engine.

### 2. Description of Related Art

An internal combustion engine described in Japanese Patent No. 6075394 includes a catalyst that is provided in an exhaust passage and having an oxygen occlusion capability, and an air-fuel ratio sensor that is provided on an exhaust upstream side of the catalyst. A control device of the internal combustion engine performs air-fuel ratio control of an air-fuel mixture based on an output value of the air-fuel ratio sensor.

### SUMMARY

During a period from engine startup being initiated until engine warm-up is completed, a state of combustion of the air-fuel mixture is not stabilized, and further fuel adhering within cylinders increases in amount. As a result, exhaust gas will contain many uncombusted components. When such uncombusted components are present, the output value of the air-fuel ratio sensor will be a value deviated from an actual air-fuel ratio. When air-fuel ratio control is performed based on the output value of the air-fuel ratio sensor in which such output deviation is occurring, the actual air-fuel ratio cannot be controlled to a target value. Accordingly, there is concern that emissions following engine startup will deteriorate.

A control device that solves the above problem is applied to an internal combustion engine includes a catalyst that is provided in an exhaust passage and that possesses an oxygen occlusion capability, an upstream-side air-fuel ratio sensor that is provided on an exhaust upstream side from the catalyst, and a downstream-side air-fuel ratio sensor that is provided on an exhaust downstream side from the catalyst, the control device performing air-fuel ratio control of an air-fuel mixture in the internal combustion engine.

This control device performs the air-fuel ratio control based on an output value of the downstream-side air-fuel ratio sensor until a predetermined period elapses after engine startup is initiated.

According to this disclosure, deterioration of emissions after engine startup can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an internal combustion engine and a peripheral structure thereof to which a control device for an internal combustion engine according to the present disclosure is embodied;

FIG. 2 is a flowchart illustrating a procedure of processing executed by the control device according to the embodiment;

FIG. 3 is a flow chart showing a sequence of a process executed by the control device according to the embodiment; and

FIG. 4 is a flowchart illustrating a procedure of processing executed by the control device according to the embodiment.

### DETAILED DESCRIPTION OF EMBODIMENTS

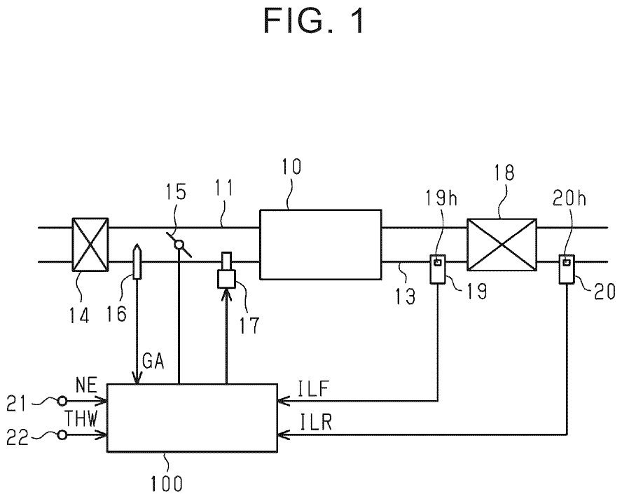

Hereinafter, an embodiment of a control device for an internal combustion engine according to the present disclosure will be described with reference to FIGS. 1 to 4. The internal combustion engine of the present embodiment is assumed to be mounted on a hybrid electric vehicle including an internal combustion engine and an electric motor as a prime mover of a vehicle, but may be mounted on a vehicle including only an internal combustion engine as a prime mover of the vehicle.

### Configuration of Internal Combustion Engine

As shown in FIG. 1, an intake passage 11 is connected to the internal combustion engine 10.

The intake passage 11 is provided with a throttle valve 15 having a variable passage area, and the amount of air sucked through the air cleaner 14 is adjusted by controlling the opening degree thereof. An intake air amount GA, which is an amount of intake air, is detected by the airflow meter 16.

The air flowing through the intake passage 11 is mixed with the fuel injected from the fuel injection valve 17 and then sent to the combustion chamber of the internal combustion engine 10 for combustion.

An exhaust gas purifying catalyst 18 for purifying components in the exhaust gas is provided in the exhaust passage 13 through which the exhaust gas generated by the combustion in the combustion chamber is sent. The catalyst 18 is, for example, a three-way catalyst. The catalyst 18 has a function of oxidizing HC and CO in the exhaust gas and reducing NOx in the exhaust gas to reduce exhaust in the vicinity of the stoichiometric air-fuel ratio. In addition, the catalyst 18 has an oxygen occlusion capability for storing oxygen in the exhaust gas and releasing the stored oxygen to the exhaust gas. When the temperature of the catalyst 18 becomes equal to or higher than the predetermined activation temperature TH1, the catalyst 18 can reduce exhaust. Further, when the temperature of the catalyst 18 becomes higher than or equal to the occlusion starting temperature TH2 higher than the activation temperature TH1, the function of the oxygen occlusion capability is obtained in the catalyst 18.

An upstream-side air-fuel ratio sensor 19 is provided on the exhaust upstream side of the catalyst 18. Further, a downstream-side air-fuel ratio sensor 20 is provided on the exhaust downstream side of the catalyst 18.

The upstream-side air-fuel ratio sensor 19 and the downstream-side air-fuel ratio sensor 20 are known limit current oxygen sensors. The limit current type oxygen sensor is a sensor that provides an output current as an output value corresponding to the oxygen concentration in the exhaust gas by providing a ceramic layer called a diffusion rate-controlling layer in a detection portion of the gray cell type oxygen sensor. In the limit current type oxygen sensor, when the air-fuel ratio closely related to the oxygen concentration in the exhaust gas is the stoichiometric air-fuel ratio, the output current becomes “0”. Further, as the air-fuel ratio becomes richer, the output current increases in the negative direction, and as the air-fuel ratio becomes leaner, the output current increases in the positive direction. Therefore, it is possible to detect the lean degree and the rich degree of the air-fuel ratio on the upstream side of the catalyst 18 based on the output value of the upstream-side air-fuel ratio sensor 19. Further, the lean degree and the rich degree of the air-fuel ratio on the downstream side of the catalyst 18 can be detected based on the output value of the downstream-side air-fuel ratio sensor 20.

The upstream-side air-fuel ratio sensor 19 includes a heater 19h that heats the sensor elements included in the upstream-side air-fuel ratio sensor 19. The downstream-side air-fuel ratio sensor 20 includes a heater 20h that heats sensor elements included in the downstream-side air-fuel ratio sensor 20.

The control device 100 controls an operation unit of the internal combustion engine 10, such as a throttle valve 15, a fuel injection valve 17, and an ignition plug, in order to control a torque, an exhaust component ratio, and the like as a control amount of the internal combustion engine 10. The control device 100 includes a memory including a CPU, a ROM, a RAM, and the like, and performs various kinds of control by CPU executing a program stored in the memory.

A detection signal of the airflow meter 16, the upstream-side air-fuel ratio sensor 19, and the downstream-side air-fuel ratio sensor 20 is input to the control device 100. The control device 100 also receives a detection signal of various sensors such as an accelerator sensor that detects the operating amount of the accelerator pedal, a crank angle sensor 21 that detects the engine rotational speed NE, and a water temperature sensor 22 that detects a coolant temperature THW that is the temperature of the coolant of the internal combustion engine 10. Then, various types of engine control are performed in accordance with the operating conditions of the internal combustion engine 10 recognized by the detection signals of the sensors.

The control device 100 acquires the impedance imp of the sensor elements included in the upstream-side air-fuel ratio sensor 19. Then, the control device 100 performs feedback control of the heater current, which is the current supplied to the heater 19h, so that the impedance imp becomes a predetermined reference value impb during the operation of the internal combustion engine 10.

Similarly, the control device 100 performs feedback control on the heater current of the heater 20h so that the impedance of the sensor elements included in the downstream-side air-fuel ratio sensor 20 becomes a predetermined reference value during the operation of the internal combustion engine 10 with respect to the downstream-side air-fuel ratio sensor 20.

### Air-Fuel Ratio Control

The control device 100 executes a so-called fuel cut in which the fuel injection from the fuel injection valve 17 is stopped at the time of deceleration of the vehicle or the like. Incidentally, within a period from the engine startup start until the completion of the engine warm-up, the combustion state of the air-fuel mixture is not stabilized, and the amount of fuel adhered in the cylinder is also increased. As a result, exhaust gas will contain many uncombusted components. When such uncombusted components are present, the output value of the air-fuel ratio sensor will be a value deviated from an actual air-fuel ratio. For example, when HC is contained in the exhaust gas as unburned components, the output value of the air-fuel ratio sensor becomes a value shifted to the lean side from the actual air-fuel ratio. Further, when hydrogen is contained in the exhaust gas as an unburned component, the output value of the air-fuel ratio sensor becomes a value shifted to the rich side from the actual air-fuel ratio. When the known air-fuel ratio control is performed based on the output value of the air-fuel ratio sensor in which the output deviation is occurring, the actual air-fuel ratio cannot be controlled to the target value. Accordingly, there is concern that emissions following engine startup will deteriorate.

Therefore, in the present embodiment, the air-fuel ratio control described below is executed.

The control device 100 calculates a target air-fuel ratio AFt which is a target value of the air-fuel ratio of the air-fuel mixture.

The control device 100 calculates an upstream-side air-fuel ratio AFf corresponding to the corrected upstream-side output value ILF2 obtained by correcting the upstream-side output value ILF, which is an output value of the upstream-side air-fuel ratio sensor 19, by referring to a preset air-fuel ratio conversion map. The corrected upstream-side output-value ILF2 will be described later.

Further, the control device 100 calculates the downstream-side air-fuel ratio AFr corresponding to the downstream output value ILR, which is the output value of the downstream-side air-fuel ratio sensor 20, by referring to a preset air-fuel ratio conversion map.

### First Air-Fuel Ratio Control

The control device 100 performs the first air-fuel ratio control for controlling the air-fuel ratio of the air-fuel mixture based on the downstream-side output-value ILR from the engine startup until a predetermined time elapses. In the present embodiment, the predetermined period is a period from the engine startup start until the catalyst 18 obtains the function of the oxygen occlusion capability.

As the first air-fuel ratio control, the control device 100 calculates a proportional term, an integral term as a learned value, and a differential term, respectively, from a deviation between the target air-fuel ratio AFt and the downstream-side air-fuel ratio AFr, a proportional gain, an integral gain, and a differential gain experimentally obtained in advance. Then, a PID control is performed to calculate the correction value for the fuel injection amount of the fuel injection valve 17 that is currently set from the sum of the proportional term, the integral term, and the differential term. Instead of PID control, a feedback control such as PI control for calculating a correction value based on the proportional term and the integral term may be performed.

Then, the control device 100 corrects the fuel injection amount using the calculated correction value. For example, when the downstream-side air-fuel ratio AFr is leaner than the target air-fuel ratio AFt, the fuel injection amount is incrementally corrected. On the other hand, when the downstream-side air-fuel ratio AFr is richer than the target air-fuel ratio AFt, the fuel injection amount is reduced and corrected. Since the feedback control of the air-fuel ratio is performed, the downstream-side air-fuel ratio AFr is controlled so as to approach the target air-fuel ratio AFt.

### Second Air-Fuel Ratio Control

After the predetermined period has elapsed, the control device 100 performs the second air-fuel ratio control for controlling the air-fuel ratio of the air-fuel mixture based on the upstream-side output-value ILF.

As the second air-fuel ratio control, the control device 100 calculates a proportional term, an integral term as a learned value, and a differential term, respectively, from a deviation between the target air-fuel ratio AFt and the upstream-side air-fuel ratio AFf, a proportional gain, an integral gain, and a differential gain experimentally obtained in advance. Then, a PID control is performed to calculate the correction value for the fuel injection amount of the fuel injection valve 17 that is currently set from the sum of the proportional term, the integral term, and the differential term. Instead of PID control, a feedback control such as PI control for calculating a correction value based on the proportional term and the integral term may be performed.

Then, the control device 100 corrects the fuel injection amount using the calculated correction value. For example, when the upstream-side air-fuel ratio AFf is leaner than the target air-fuel ratio AFt, the fuel injection amount is incrementally corrected. On the other hand, when the upstream-side air-fuel ratio AFf is richer than the target air-fuel ratio AFt, the fuel injection amount is reduced and corrected. Since the feedback control of the air-fuel ratio is performed, the upstream-side air-fuel ratio AFf is controlled so as to approach the target air-fuel ratio AFt.

### Sub Air-Fuel Ratio Control

When the second air-fuel ratio control is executed, the control device 100 also executes the sub air-fuel ratio control. As the sub-air-fuel ratio control, the control device 100 calculates a proportional term, an integral term as a learned value, and a differential term, respectively, from a deviation between the sub-target air-fuel ratio AFts and the downstream-side air-fuel ratio AFr, a proportional gain, an integral gain, and a differential gain experimentally obtained in advance. Then, a PID control is performed to calculate the correction value for the currently set target air-fuel ratio AFt from the sum of the proportional term, the integral term, and the differential term. Instead of PID control, a feedback control such as PI control for calculating a correction value based on the proportional term and the integral term may be performed.

Then, the control device 100 corrects the target air-fuel ratio AFt using the calculated correction value. For example, when the downstream-side air-fuel ratio AFr is leaner than the sub-target air-fuel ratio AFts, the target air-fuel ratio AFt is corrected so that the target air-fuel ratio AFt changes to the rich-side value. On the other hand, when the downstream-side air-fuel ratio AFr is richer than the sub-target air-fuel ratio AFts, the target air-fuel ratio AFt is corrected so that the target air-fuel ratio AFt changes to the lean-side value. Then, the second air-fuel ratio control is executed based on the corrected target air-fuel ratio AFt. By performing such sub-air-fuel ratio control, the function of the oxygen occlusion capability in the catalyst 18 can be appropriately obtained.

### Switching of Air-Fuel Ratio Control

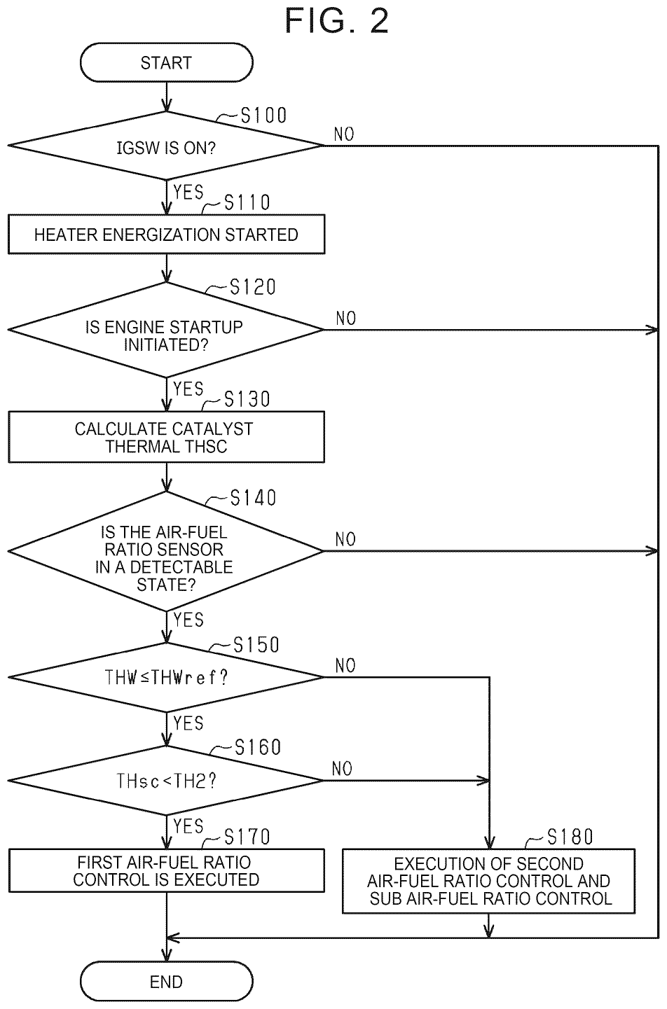

FIG. 2 shows a procedure of processing executed by the control device 100 in order to perform the above-described switching of the air-fuel ratio control. In the following, the step number of each process is represented by a number prefixed with “S”.

When the process illustrated in FIG. 2 is started, the control device 100 determines whether the ignition switch (IGSW) provided in the vehicle is in ON (S100).

In S100 process, when it is determined that the ignition switch is ON (S100: YES), the control device 100 starts energizing the heater 19h and the heater 20h provided in the air-fuel ratio sensor (S110). When the heater 19h and the heater 20h are energized, the upstream-side air-fuel ratio sensor 19 and the downstream-side air-fuel ratio sensor 20 are activated at an early stage and become detectable even before the engine startup is actually started.

Next, the control device 100 determines whether or not the engine startup is initiated (S120). When it is determined that the engine startup is initiated (S120: YES), the control device 100 calculates the catalyst temperature THsc (S130). The catalyst temperature THsc is the temperature of the catalyst 18 and is estimated by the control device 100. For example, the control device 100 calculates the catalyst temperature THsc on the basis of the accumulated air quantity after engine startup is initiated, the detected value of the sensor for detecting the temperature of the exhaust gas, and the like.

Next, the control device 100 determines whether the upstream-side air-fuel ratio sensor 19 and the downstream-side air-fuel ratio sensor 20 are in a detectable status (S140). In S140 process, the control device 100 determines that the upstream-side air-fuel ratio sensor 19 and the downstream-side air-fuel ratio sensor 20 are in a detectable state, for example, when both the following conditions (a) and (b) are satisfied.

Condition (a): Both the upstream-side air-fuel ratio sensor 19 and the downstream-side air-fuel ratio sensor 20 have not failed.

Condition (b): Both the upstream-side air-fuel ratio sensor 19 and the downstream-side air-fuel ratio sensor 20 are activated.

In S140 process, when it is determined that the upstream-side air-fuel ratio sensor 19 and the downstream-side air-fuel ratio sensor 20 are in a detectable condition (S140: YES), the control device 100 acquires the coolant temperature THW. Then, it is determined whether or not the obtained value is equal to or less than the threshold THWref (S150). The threshold THWref is a preset fit value. For example, when the warm-up of the internal combustion engine 10 is advanced and the coolant temperature THW is higher to some extent, the combustion condition of the air-fuel mixture is stabilized, so that the output deviation of the air-fuel ratio sensor is reduced. Therefore, the maximum temperature or the like of the coolant temperature THW at which the output-deviation of the air-fuel ratio sensor is likely to occur may be set to the threshold THWref.

In S150 process, when it is determined that the coolant temperature THW is equal to or lower than the threshold THWref (S150: YES), the control device 100 determines whether or not the present catalyst temperature THsc is lower than the above-described occlusion starting temperature TH2 (S160).

In S160 process, when it is determined that the catalyst temperature THsc is less than the occlusion starting temperature TH2 (S160: YES), the control device 100 executes the above-described first air-fuel ratio control (S170).

On the other hand, if a negative determination is made in S150 process or if a negative determination is made in S160 process, the control device 100 executes the second air-fuel ratio control and the sub-air-fuel ratio control described above (S180).

When the process of S170 or the process of S180 is terminated, or when a negative determination is made in any of the processes of S100, S120, and S140, the control device 100 terminates the process.

### Calculation of Correction Value for Correcting the Upstream Output Value

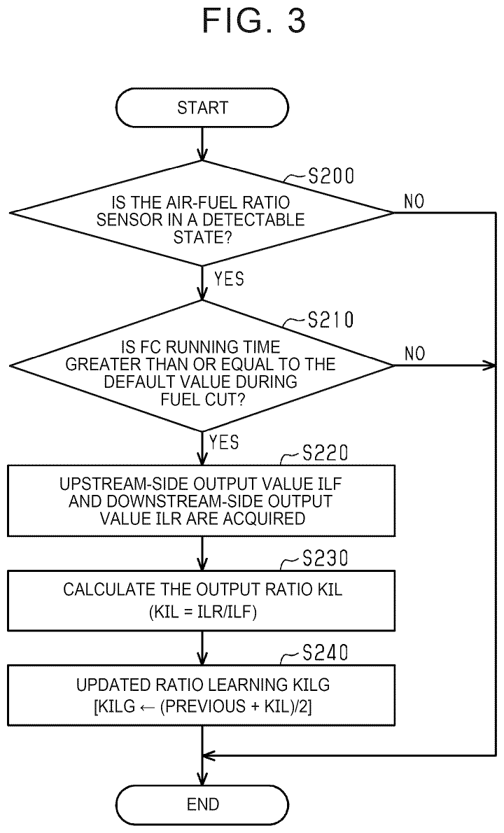

FIG. 3 shows a sequence of a process executed by the control device 100 at every predetermined execution cycle in order to calculate a ratio learned value KILG which is a correction value for correcting the upstream-side output value ILF.

When the process illustrated in FIG. 3 is started, the control device 100 determines whether the upstream-side air-fuel ratio sensor 19 and the downstream-side air-fuel ratio sensor 20 are in a detectable status (S200). S200 process is the same as S140 process described above.

In S200 process, when it is determined that the upstream-side air-fuel ratio sensor 19 and the downstream-side air-fuel ratio sensor 20 are in a detectable condition (S200: YES), the control device 100 executes S210 process.

In S210 process, the control device 100 determines whether or not the above-described fuel cut is currently being executed and FC running time is equal to or greater than a predetermined value a. FC execution time is an elapsed time since the fuel cut is started. In the predetermined value a, a period from when the fuel cut is started until the value of the downstream-side output value ILR is stabilized is set in advance.

In S210 process, when it is determined that the fuel cut is being executed and FC executing time is equal to or more than the predetermined value a (S210: YES), the control device 100 acquires the upstream-side output value ILF and the downstream-side output value ILR (S220).

Next, the control device 100 calculates the output ratio KIL (S230). The output ratio KIL is a value for correcting the upstream-side output value ILF, and is calculated based on a difference between the upstream-side output value ILF and the downstream-side output value ILR. The control device 100 calculates a value obtained by dividing the downstream-side output value ILR by the upstream-side output value ILF. Then, the calculated value is substituted into the output ratio KIL (KIL=ILR/ILF).

Next, the control device 100 updates the ratio learned value KILG by smoothing the calculated output ratio KIL (S240). In S240 process, the control device 100 calculates the updated value of the ratio learned value KILG based on, for example, the following Expression (1).

Updated value of ratio learned value KILG=(previous value of ratio learned value KILG+output ratio KIL calculated this time)/2 (1)

The ratio learned value KILG thus updated is stored in a memory (for example, a backup RAM) of the control device 100.

### Correction of Upstream Output Value and Calculation of Upstream Air-Fuel Ratio

When the process of S240 is ended, the control device 100 ends the present process in the current run cycle.

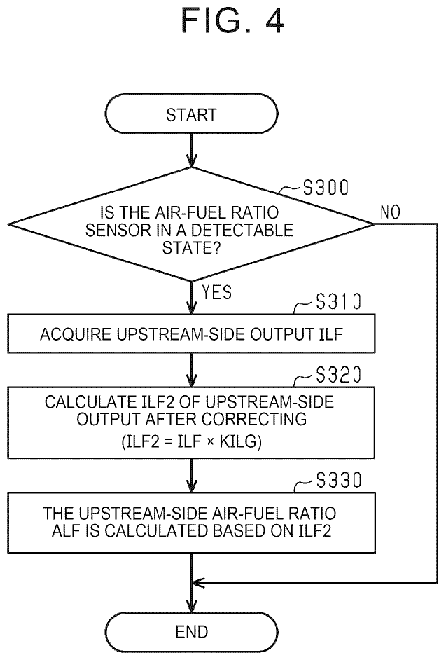

FIG. 4 shows a sequence of a process executed by the control device 100 at every predetermined execution cycle in order to calculate the corrected upstream-side output value ILF2 after correcting the upstream-side output value ILF and to calculate the upstream-side air-fuel ratio AFf.

When the process illustrated in FIG. 4 is started, the control device 100 determines whether the upstream-side air-fuel ratio sensor 19 and the downstream-side air-fuel ratio sensor 20 are in a detectable status (S300). S300 process is the same as S140 process described above.

In S300 process, when it is determined that the upstream-side air-fuel ratio sensor 19 and the downstream-side air-fuel ratio sensor 20 are in a detectable state (S300: YES), the control device 100 acquires the upstream-side output-value ILF (S310).

Next, the control device 100 calculates the corrected upstream-side output-value ILF2 (S320). In S320 process, the control device 100 reads the ratio learned value KILG stored in the memory, and substitutes a value obtained by multiplying the read value by the upstream-side output value ILF into the corrected upstream output value ILF2.

Next, the control device 100 calculates the upstream-side air-fuel ratio AFf based on the corrected upstream-side output-value ILF2 (S330). In S330 process, as described above, the control device 100 refers to a preset air-fuel ratio conversion map and calculates an upstream-side air-fuel ratio AFf corresponding to the corrected upstream-side output-value ILF2.

### Operation and Effect of this Embodiment

When the process of S330 is ended, the control device 100 ends the present process in the current run cycle.

(1) Even if unburned components such as HC and hydrogen-gas are contained in the exhaust gas within a period from the engine startup start until the completion of the engine warm-up, the unburned components are purified when passing through the catalyst 18. Therefore, the output value of the downstream-side air-fuel ratio sensor 20 provided on the exhaust downstream side of the catalyst 18 is smaller in output deviation due to unburned components than the output value of the upstream-side air-fuel ratio sensor 19 provided on the exhaust upstream side of the catalyst 18. Therefore, in the present embodiment, the first air-fuel ratio control, which is the air-fuel ratio control based on the output value of the downstream-side air-fuel ratio sensor 20 having a small output deviation, is performed until a predetermined period elapses after the engine startup. Therefore, it is possible to suppress the deterioration of the emissions after the engine startup.

(2) When the function of the oxygen occlusion capability is obtained in the catalyst 18, the catalyst 18 occludes or releases oxygen, and thus there may be a period in which the output value of the downstream-side air-fuel ratio sensor 20 and the air-fuel ratio of the air-fuel mixture do not coincide with each other. In addition, since a certain amount of time has elapsed since the engine startup is started, the combustion state of the air-fuel mixture is improved and the unburned component contained in the exhaust gas is reduced at the time when the function of the oxygen occlusion capability is obtained in the catalyst 18. Therefore, when the function of the oxygen occlusion capability is obtained in the catalyst 18, the output deviation of the upstream-side air-fuel ratio sensor 19 becomes small.

Therefore, in the present embodiment, the predetermined period is a period from initiating engine startup until the catalyst 18 obtains the function of the oxygen occlusion capability, and after the predetermined period elapses, the second air-fuel ratio control based on the output value of the upstream-side air-fuel ratio sensor 19 is performed.

In this case, the first air-fuel ratio control, which is the air-fuel ratio control based on the output value of the downstream-side air-fuel ratio sensor 20, is performed during the period from the engine startup start until the oxygen occlusion capability function is obtained in the catalyst 18. On the other hand, when the function of the oxygen occlusion capability is obtained in the catalyst 18, the second air-fuel ratio control, which is the air-fuel ratio control based on the output value of the upstream-side air-fuel ratio sensor 19, is performed. Therefore, switching from the air-fuel ratio control based on the output value of the downstream-side air-fuel ratio sensor 20 to the air-fuel ratio control based on the output value of the upstream-side air-fuel ratio sensor 19 can be performed at an appropriate timing.

(3) The detection targets of the upstream-side air-fuel ratio sensor 19 and the downstream-side air-fuel ratio sensor 20 when the fuel cut is executed in the internal combustion engine 10 are both the same fresh air. Therefore, the difference between the output values of the upstream-side air-fuel ratio sensor 19 and the downstream-side air-fuel ratio sensor 20 when the fuel cut is executed indicates an error in the output value between the individual pieces of the upstream-side air-fuel ratio sensor 19 and the downstream-side air-fuel ratio sensor 20.

Therefore, in the present embodiment, the output value of the upstream-side air-fuel ratio sensor 19 and the output value of the downstream-side air-fuel ratio sensor 20 are acquired when the fuel cut is executed in the internal combustion engine 10. Then, the output value of the upstream-side air-fuel ratio sensor 19 is corrected by using the ratio learned value KILG obtained by smoothing the output ratio KIL, which is a correction value calculated based on the difference between the obtained output value of the upstream-side air-fuel ratio sensor 19 and the obtained output value of the downstream-side air-fuel ratio sensor 20. Therefore, an error in the output value between the upstream-side air-fuel ratio sensor 19 and the downstream-side air-fuel ratio sensor 20 can be suppressed.

(4) In the present embodiment, the correction value for correcting the output value of the upstream-side air-fuel ratio sensor 19 is a value multiplied by the output value of the upstream-side air-fuel ratio sensor 19, and is a value obtained by dividing the output value of the downstream-side air-fuel ratio sensor 20 by the output value of the upstream-side air-fuel ratio sensor 19. Therefore, the output value of the upstream-side air-fuel ratio sensor 19 can be corrected based on the output value of the downstream-side air-fuel ratio sensor 20.

### Modifications

The above-described embodiment can be modified as follows. The above-described embodiments and the following modifications can be implemented in combination with each other as long as they are not technically contradictory.
The process of S110 shown in FIG. 2 may be omitted, and the energization starting time of the heater 19h and the heater 20h may be set to another time.
The process of S150 illustrated in FIG. 2 may be omitted.
The process of S240 shown in FIG. 3 is omitted. Then, in the process of S320 illustrated in FIG. 4, the corrected upstream-side output value ILF2 may be calculated by multiplying the upstream-side output value ILF by the output ratio KIL calculated in the process of S230 illustrated in FIG. 3, instead of the ratio learned value KILG.
By omitting the series of processes illustrated in FIGS. 3 and 4, the upstream-side output-value ILF may not be corrected. Even in this case, effects and effects other than the above (3) and (4) can be obtained.
The control device 100 includes a CPU and a memory, and is not limited to a device that executes a software process. For example, the control device 100 may comprise dedicated hardware circuitry, such as an ASIC, for hardware processing at least a portion of what has been software processed in the above embodiments. That is, the control device 100 may include a processing circuit having any of the following configurations (a) to (c). (a) A processing circuitry comprising: one or more processing devices for executing all of the above processing in accordance with a program; and one or more program storage devices, such as a ROM for storing the program. (b) A processing circuit comprising: one or more processing devices and one or more program storage devices that execute a portion of the above processing according to a program; and one or more dedicated hardware circuits that execute the remaining processing. (c) A processing circuit comprising one or more dedicated hardware circuits for performing all of the above processing. Program storage or computer readable media includes any available media that can be accessed by a general purpose or special purpose computer.

What is claimed is:

1. A control device that is applied to an internal combustion engine including a catalyst that is provided in an exhaust passage and that possesses an oxygen occlusion capability, an upstream-side air-fuel ratio sensor that is provided on an exhaust upstream side from the catalyst, and a downstream-side air-fuel ratio sensor that is provided on an exhaust downstream side from the catalyst, the control device performing air-fuel ratio control of an air-fuel mixture in the internal combustion engine, wherein the air-fuel ratio control is performed based on an output value of the downstream-side air-fuel ratio sensor until a predetermined period elapses after engine startup is initiated.

2. The control device according to claim 1, wherein the predetermined period is a period from when engine startup is initiated until the catalyst obtains the oxygen occlusion capability, and after the predetermined period elapses, the air-fuel ratio control is performed based on an output value of the upstream-side air-fuel ratio sensor.

3. The control device according to claim 1, wherein:
when fuel cut is executed in the internal combustion engine, an output value of the upstream-side air-fuel ratio sensor and the output value of the downstream-side air-fuel ratio sensor are obtained; and
the output value of the upstream-side air-fuel ratio sensor is corrected using a correction value that is calculated based on a difference between the output value that is obtained from the upstream-side air-fuel ratio sensor and the output value that is obtained from the downstream-side air-fuel ratio sensor.

4. The control device according to claim 3, wherein the correction value is a value by which the output value of the upstream-side air-fuel ratio sensor is multiplied, and is a value that is obtained by dividing the output value of the downstream-side air-fuel ratio sensor by the output value of the upstream-side air-fuel ratio sensor.
